(19) United States
(12) Patent Application Publication
(10) Pub. No.: US 2021/0292917 A1
(43) Pub. Date: Sep. 23, 2021

(54) HYDROGEN PRODUCTION AND STORAGE SYSTEM USING SOLAR ENERGY INDEPENDENTLY OPERATED WITHOUT EXTERNAL POWER

(71) Applicant: KOREA INSTITUTE OF SCIENCE AND TECHNOLOGY, Seoul (KR)

(72) Inventors: Ung LEE, Seoul (KR); Byoung Koun MIN, Seoul (KR); Hyun Joo LEE, Seoul (KR); Yun Jeong HWANG, Seoul (KR); Hyung Suk OH, Seoul (KR); Dong Ki LEE, Seoul (KR); Da Hye WON, Seoul (KR); Jai Hyun KOH, Seoul (KR); Dong Gu HAN, Seoul (KR)

(73) Assignee: KOREA INSTITUTE OF SCIENCE AND TECHNOLOGY, Seoul (KR)

(21) Appl. No.: 17/017,845

(22) Filed: Sep. 11, 2020

(30) Foreign Application Priority Data
Mar. 23, 2020 (KR) 10-2020-0034865

(51) Int. Cl. C25B 1/00; C25B 1/10; C25B 9/08; C25B 9/18; C25B 15/08; B01D 53/26; H02S 10/40; H02S 30/10; H02S 40/30

(52) U.S. Cl. CPC C25B 1/003; C25B 1/10; C25B 9/08; C25B 9/18; H02S 40/30; B01D 53/26; H02S 10/40; H02S 30/10; C25B 15/08

(57) ABSTRACT

Disclosed is a hydrogen production and storage system using solar energy which converts solar energy into electric energy through a solar panel, operates a water electrolysis reactor using the electric energy to produce hydrogen, and stores the hydrogen at a high pressure in a hydrogen storage tank through a water tank, a pressure control valve, etc.

### CROSS-REFERENCE TO RELATED APPLICATION

This application claims under 35 U.S.C. § 119(a) the benefit of priority to Korean Patent Application No. 10-2020-0034865 filed on Mar. 23, 2020, the entire contents of which are incorporated herein by reference.

### BACKGROUND

### (a) Technical Field

The present disclosure relates to a hydrogen production and storage system which is operated using energy generated by a solar panel.

### (b) Background Art

As use of energy resources is increasing and fossil fuels are in danger of running out, requirement for research and development of alternative sources of energy is being increased now. Among such alternative sources of energy, solar energy is being spotlighted.

Solar energy generation is a technology which is clean and safe and does not require transportation of fuel, maintenance and repair, and thus is expected to serve as a future energy source capable of obtaining unlimited electricity. However, because solar energy generation uses an intermittent energy source which is capable of producing power only when the sun shines, in order to use solar energy generation in a continuous manner, energy must be produced and then stored in other media. Therefore, production of hydrogen through water electrolysis is considered a desirable power storage medium.

As one of water electrolysis methods, there is a method for using a solid polymer electrolyte member as an electrolyte. The membrane used in this method separates generated gas in the manner of a diaphragm in alkaline water electrolysis, and serves to realize ion exchange in which hydrogen ions move towards a cathode from an anode.

Reactions at the respective electrodes are as follows.

4H⁺+4e⁻→2H₂ Cathode:

2H₂O→4H⁺+4e⁻+O₂ Anode:

In this method, the electrolyte is stabilized, a cell structure is simple, and pure water is used and thus the electrolyte is not corrosive. Further, an apparatus used in this method is operable at a high current density and has high efficiency compared to alkaline water electrolysis. However, the apparatus has drawbacks, such as high installation costs and low capacity. In addition, the apparatus has low efficiency and a short lifespan.

The above information disclosed in this Background section is only for enhancement of understanding of the background of the invention, and therefore it may contain information that does not form the prior art that is already known in this country to a person of ordinary skill in the art.

### SUMMARY OF THE DISCLOSURE

The present invention has been made in an effort to solve the above-described problems associated with the prior art, and it is an object of the present invention to construct a series of systems which convert solar energy into electric energy and then convert the electric energy into hydrogen energy.

It is another object of the present invention to construct an energy system which is capable of being autonomously operated only using electric energy produced by a solar panel.

It is still another object of the present invention to construct an energy system which may produce high-pressure hydrogen using a photoelectrochemical cell configured to convert solar energy into hydrogen, without any external power source, such as a compressor.

It is yet another object of the present invention to package the above-described series of systems so as to be simply installed.

In one aspect, the present invention provides a hydrogen production and storage system using solar energy, including a solar panel configured to produce electric energy from sunlight, a water tank configured to store water, a water electrolysis reactor configured to receive the water from the water tank and to decompose the water so as to produce hydrogen, and operated by the electric energy received from the solar panel, a hydrogen collection pipe connected to the water electrolysis reactor and the water tank so as to supply the hydrogen produced by the water electrolysis reactor to the water tank, and a hydrogen storage tank connected to the water tank through a hydrogen transfer pipe so as to receive and store the hydrogen collected in the water tank.

In a preferred embodiment, the hydrogen production and storage system may further include a subsidiary water tank spatially separated from the water tank and configured to store water, and the water electrolysis reactor may receive the water from at least one of the water tank or the subsidiary water tank and decompose the water so as to produce the hydrogen and oxygen.

In another preferred embodiment, the hydrogen production and storage system may further include an oxygen collection pipe connected to the water electrolysis reactor and the subsidiary water tank so as to supply the oxygen produced by the water electrolysis reactor to the subsidiary water tank, and an oxygen collection tank connected to the subsidiary water tank through an oxygen transfer pipe so as to receive and store the oxygen collected in the subsidiary water tank.

In still another preferred embodiment, the solar panel may be installed at an incline on an upper surface of a support formed by combining a plurality of frames, and at least one of the water tank, the water electrolysis reactor or the hydrogen storage tank may be received in an inner space formed by the solar panel and the support.

In yet another preferred embodiment, the solar panel may include a first panel configured to absorb at least one of infrared light or ultraviolet light and to produce electric energy, and a second panel configured to absorb visible light and to produce electric energy, and the first panel may be installed on a front surface of the second panel.

In still yet another preferred embodiment, the water tank may be installed on a rear surface of the solar panel, and a heat exchange pad configured to transmit heat generated from the solar panel to the water tank may be interposed between the water tank and the solar panel.

In a further preferred embodiment, the water electrolysis reactor may include at least one water electrolysis cell including a cathode configured to generate hydrogen, an anode configured to generate oxygen, and a cation exchange membrane interposed between the cathode and the anode, a hydrogen channel having one side communicating with the cathode and a remaining side communicating with the hydrogen collection pipe so as to guide the hydrogen generated at the cathode to the hydrogen collection pipe, and an oxygen channel having one side communicating with the anode and a remaining side communicating with the oxygen collection pipe so as to guide the oxygen generated at the anode to the oxygen collection pipe.

In another further preferred embodiment, the water electrolysis reactor may be formed by stacking a plurality of water electrolysis cells.

In still another further preferred embodiment, the hydrogen supplied to the water tank via the hydrogen collection pipe may be collected in an accommodation space other than a portion of the water tank in which the water is stored, the hydrogen may be pressurized as an amount of the collected hydrogen increases in a closed state of a pressure control valve installed in the hydrogen transfer pipe, and the hydrogen may be stored in the hydrogen storage tank when a pressure of the hydrogen becomes equal to or higher than a predetermined pressure and the pressure control valve is opened.

In yet another further preferred embodiment, the oxygen supplied to the subsidiary water tank via the oxygen collection pipe may be collected in an accommodation space other than a portion of the subsidiary water tank in which the water is stored, the oxygen may be pressurized as an amount of the collected oxygen increases in a closed state of a pressure control valve installed in the oxygen transfer pipe, and the oxygen may be stored in the oxygen storage tank when a pressure of the oxygen becomes equal to or higher than a predetermined pressure and the pressure control valve is opened.

In still yet another further preferred embodiment, the hydrogen production and storage system may further include a dehumidifier installed in the hydrogen transfer pipe to remove moisture from the hydrogen flowing in the hydrogen transfer pipe.

In a still further preferred embodiment, the hydrogen production and storage system may further include a dehumidifier installed in the oxygen transfer pipe to remove moisture from the oxygen flowing in the oxygen transfer pipe.

In a yet still further preferred embodiment, the hydrogen production and storage system may be independently operated without power supplied from an external power source.

Other aspects and preferred embodiments of the invention are discussed infra.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a view schematically illustrating a hydrogen production and storage system using solar energy according to the present invention;

FIG. 2 is a view schematically illustrating the front surface of a first panel according to the present invention;

FIG. 3 is a view schematically illustrating the front surface of a second panel according to the present invention;

FIG. 4 is a view schematically illustrating peripheral elements including a water tank and a water electrolytic reactor according to the present invention; and

FIG. 5 is a cross-sectional view schematically illustrating the water electrolytic reactor according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawings.

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein, and may be implemented in various different forms. The aspects are provided to make the description of the present disclosure thorough and to fully convey the scope of the present disclosure to those skilled in the art.

In the following description of the embodiments, the same or similar elements are denoted by the same reference numerals even when they are depicted in different drawings. The shapes, sizes, ratios, angles, and number of elements given in the drawings are merely exemplary, and thus, the present disclosure is not limited to the illustrated details. In the following description of the embodiments, terms, such as “first” and “second”, are used only to describe various elements, and these elements should not be construed to be limited by these terms. These terms are used only to distinguish one element from other elements. For example, a first element described hereinafter may be termed a second element, and similarly, a second element described hereinafter may be termed a first element, without departing from the scope of the invention. It will be understood that a singular expression of an element(s) encompasses a plural expression unless the context clearly indicates otherwise.

In the following description of the embodiments, terms, such as “comprising”, “including”, “having”, etc., will be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus, it will be understood that they are to be modified by the term “about” unless stated otherwise. In addition, it will be understood that, if a numerical range is disclosed in the description, the range includes all continuous values from a minimum value to a maximum value of the range, unless stated otherwise. Further, if such a range refers to integers, the range includes all integers from a minimum integer to a maximum integer thereof, unless stated otherwise.

The present invention relates to an energy system which converts solar energy into electric energy and then converts the electric energy into hydrogen energy. Hereinafter, this energy system according to the present invention will be referred to as a hydrogen production and storage system using solar energy, but this is only to describe the energy system and the scope of the invention is not limited to a system for producing and storing hydrogen.

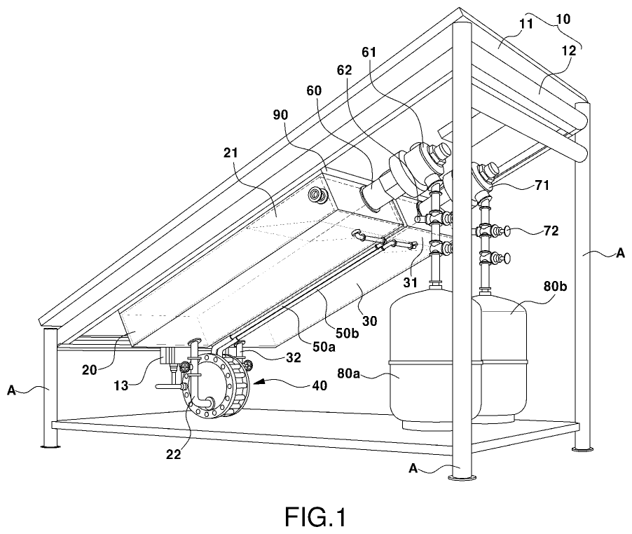

FIG. 1 is a view schematically illustrating the hydrogen production and storage system using solar energy. Referring to this figure, a hydrogen production and storage system 1 according to the present invention includes a solar panel 10 configured to produce electric energy from sunlight, a water tank 20 configured to store water, a subsidiary water tank 30 spatially separated from the water tank 20 and configured to store water, a water electrolysis reactor 40 configured to receive water from the water tank 20 and/or the subsidiary water tank 30 and to decompose the water so as to produce hydrogen and oxygen, and operated by the electric energy received from the solar panel 10, a hydrogen collection pipe 50a connected to the water electrolysis reactor 40 and the water tank 20 so as to supply the hydrogen produced by the water electrolysis reactor 40 to the water tank 20, an oxygen collection pipe 50b connected to the water electrolysis reactor 40 and the subsidiary water tank 30 so as to supply the oxygen produced by the water electrolysis reactor 40 to the subsidiary water tank 30, a hydrogen storage tank 80a connected to the water tank 20 through a hydrogen transfer pipe 60 so as to receive and store the hydrogen collected in the water tank 20, and an oxygen collection tank 80b connected to the subsidiary water tank 30 through an oxygen transfer pipe 70 so as to receive and store the oxygen collected in the subsidiary water tank 30.

In the hydrogen production and storage system 1, the solar panel 10 may be installed at an incline on the upper surface of a support which is formed by organically combining a plurality of frames A. All or some of the respective elements of the above-described hydrogen production and storage system 1 may be received in a kind of internal space formed by the solar panel 10 and the support. Particularly, at least the water tank 20, the subsidiary water tank 30 and the water electrolysis reactor 40 may be received in the internal space. The present invention is characterized in that the respective elements of the hydrogen production and storage system 1 are packaged in a densely disposed manner, as shown in FIG. 1. Thereby, the hydrogen production and storage system 1 may be easily installed in a small space.

Further, the hydrogen production and storage system 1 may be configured to be portable by installing wheels at the lower ends of the frames A of FIG. 1.

Hereinafter, the respective elements of the hydrogen production and storage system 1 will be described in detail.

The solar panel 10 serves to absorb sunlight and then produce electric energy. The solar panel 10 may include a first panel 11 configured to absorb at least one of infrared light or ultraviolet light and a second panel 12 configured to absorb visible light, and further include a power converter 13 configured to convert solar energy into electric energy as needed. The power converter 13 may be, for example, a DC/DC converter.

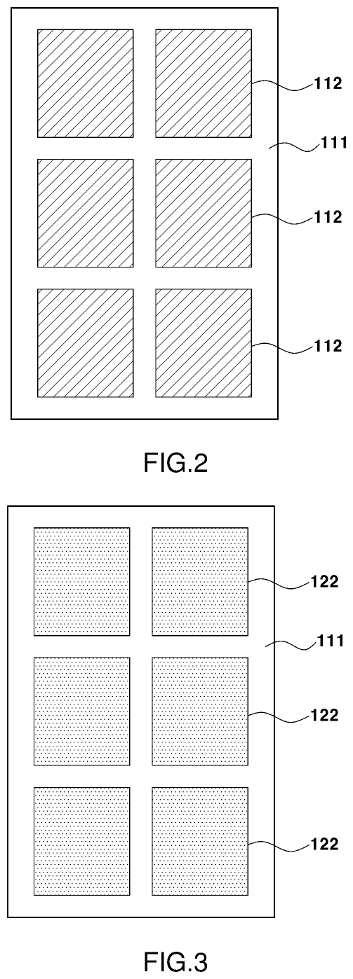

FIG. 2 is a view schematically illustrating the front surface of the first panel 11 according to the present invention. Referring to this figure, the first panel 11 may include a substrate 111 and a plurality of solar cell modules 112 installed on the substrate 111.

FIG. 3 is a view schematically illustrating the front surface of the second panel 12 according to the present invention. Referring to this figure, the second panel 12 may include a substrate 121 and a plurality of solar cell modules 122 installed on the substrate 121.

When the first panel 11 and the second panel 12 are stacked to form the solar cell panel 10, the solar cell panel 10 may produce electric energy using sunlight of a wide spectrum including infrared light, visible light and ultraviolet light. The first panel 11 may be installed on the front surface of the second panel 12, without being limited thereto.

Electric energy produced by the solar panel 10 may be used as operating power of the water electrolysis reactor 40 which will be described below. The solar panel 10 according to the present invention uses the wide solar spectrum, and thus produces a large amount of electric energy which is sufficient to operate the water electrolysis reactor 40. Therefore, the water electrolysis reactor 40 is operated using electric energy produced by the solar panel 10 without external power.

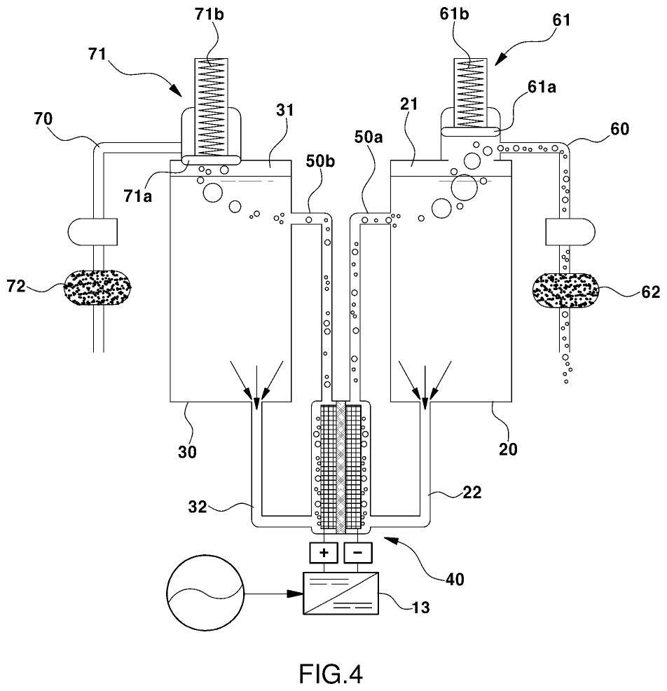

FIG. 4 is a view schematically illustrating peripheral elements including the water tank 20 and the water electrolytic reactor 40 according to the present invention.

The water tank 20 stores water necessary for water electrolysis. An amount of stored water is not specially limited, and may be appropriately adjusted depending on the capacity of the water tank 20, the performance of the water electrolysis reactor 40, desired amounts of stored hydrogen and oxygen, etc. However, as will be described below, hydrogen is collected in an accommodation space 21 other than the portion of the water tank 20 in which water is stored, and thus, it is desirable that the inside of the water tank 20 is not completely filled with water. For example, the water tank 20 may be controlled such that water fills 80% or less of the volume of the water tank 20.

The subsidiary water tank 30 is spatially separated from the water tank 20, and stores water necessary for water electrolysis in the same manner as the water tank 20. The reason why the subsidiary water tank 30 is spatially separated from the water tank 20 is to prevent hydrogen and oxygen produced in the water electrolysis reactor 40 from mixing. This will be described in more detail below. “Spatial separation” between the water tank 20 and the subsidiary water tank 30 may mean that the water tank 20 and the subsidiary water tank 30 are separately provided at different positions, or that the water tank 20 and the subsidiary water tank 20 are compartments which are spatially isolated through a partition in one large water tank.

Although FIGS. 1 and 3 illustrate one water tank 20 and one subsidiary water tank 30, this is only example to clearly describe the invention and the present invention is not limited thereto. That is, a plurality of water tanks 20 and a plurality of subsidiary water tanks 30 may be provided. In this case, tanks configured to collect hydrogen produced by the water electrolysis reactor 40 may be classified as water tanks 20, and tanks configured to collect oxygen produced by the water electrolysis reactor 40 may be classified as subsidiary water tanks 30. Further, if the water tanks 20 are provided in plural and the subsidiary water tanks 30 are provided in plural, water supply pipes 22 and 32, the hydrogen collection pipe 50a, the oxygen collection pipe 50b, the hydrogen transfer pipe 60, and the oxygen transfer pipe 70 may be individually installed in the respective water tanks 20 and/or subsidiary water tanks 30.

The water tank 20 and the subsidiary water tank 30 may be installed on the rear surface of the solar panel 10. They serve to exchange heat between the respective elements, thereby being capable of preventing overheating of the solar panel 10 and heating the water stored in the water tank 20 and the subsidiary water tank 30 to a temperature appropriate for water electrolysis so as to improve hydrogen and oxygen production efficiency.

The water tank 20 and the subsidiary water tank 30 may be installed on a heat exchange pad 90 provided on the rear surface of the solar panel 10. The heat exchange pad 90 may be any material which facilitates heat conduction.

The water stored in the water tank 20 and the subsidiary water tank 30 may be supplied to the water electrolysis reactor 40 through the water supply pipes 22 and 32. The water supply pipes 22 and 32 may be installed at the lower portions of the water tank 20 and the subsidiary water tank 30, without being limited thereto. Thereby, the water stored in the water tank 20 and the subsidiary water tank 30 may be supplied to the water electrolysis reactor 40 through gravity or water pressure without external power.

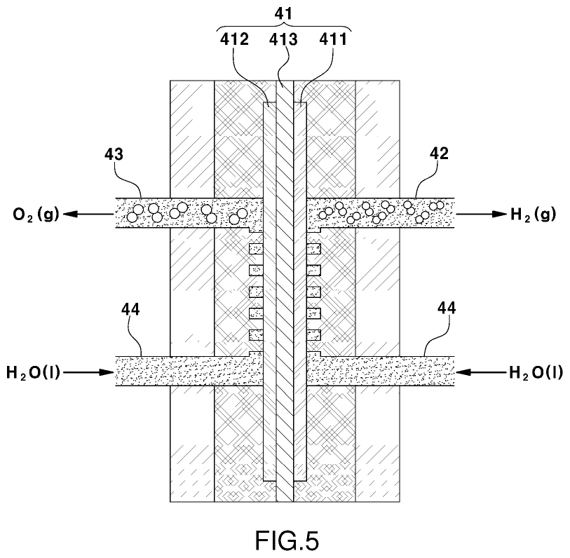

FIG. 5 is a cross-sectional view schematically illustrating the water electrolytic reactor 40 according to the present invention. Referring to this figure, the water electrolysis reactor 40 includes a water electrolysis cell 41 configured to decompose water into hydrogen and oxygen.

The water electrolysis cell 41 may include a cathode 411 configured to generate hydrogen, an anode 412 configured to generate oxygen, and a cation exchange membrane 413 interposed between the cathode 411 and the anode 412.

The water electrolysis reactor 40 may be electrically connected to the solar panel 10 and be operated by electric energy produced by the solar panel 10.

Although FIGS. 1 and 4 illustrate one water electrolysis cell 41, this is only example to clearly describe the invention and the present invention is not limited thereto. The water electrolysis reactor 40 may be formed by stacking a plurality of water electrolysis cells 41.

The water electrolysis reactor 40 may include a hydrogen channel 42 having one side communicating with the cathode 411 and the other side communicating with the hydrogen collection pipe 50a so as to guide hydrogen generated at the cathode 411 to the hydrogen collection pipe 50a, an oxygen channel 43 having one side communicating with the anode 412 and the other side communicating with the oxygen collection pipe 50b so as to guide oxygen generated at the anode 412 to the oxygen collection pipe 50b, and water channels 44 into which water supplied from the water tank 20 and/or the subsidiary water tank 30 is introduced.

Hydrogen generated at the cathode 411 may be supplied to the water tank 20 through the hydrogen collection pipe 50a. The hydrogen supplied to the water tank 20 is collected in the accommodation space 21 other than the portion of the water tank 20 in which water is stored. Therefore, the hydrogen collection pipe 50a may be connected to the upper portion of the water tank 20. In this case, the hydrogen generated at the cathode 411 may move towards the water tank 20 without external power.

The hydrogen collected in the accommodation space 21 is stored in the hydrogen storage tank 80a via the hydrogen transfer pipe 60. However, the hydrogen is not capable of being stored in the hydrogen storage tank 80a at a high pressure using only the hydrogen production rate of the water electrolysis reactor 40 and the hydrogen collection rate of the water tank 20. Therefore, in the present invention, a pressure control valve 61 is installed in the hydrogen transfer pipe 60 so that the hydrogen may be stored at a high pressure. In more detail, in the closed state of the pressure control valve 61, hydrogen is continuously supplied to the accommodation space 21 which is a restricted space. As the amount of the collected hydrogen increases, pressure applied to the hydrogen is increased. When the pressure of the hydrogen becomes equal to or higher than a predetermined pressure, the pressure control valve 61 is opened and the high-pressure hydrogen is supplied to the hydrogen storage tank 80a via the hydrogen transfer pipe 60. The predetermined pressure of the hydrogen is not specifically limited, and may be, for example, 200 bar, 300 bar or 400 bar. The pressure control value 61 may include a lid 61a configured to prevent movement of the hydrogen and an elastic member 61b moving in connection with the lid 61a, without being limited thereto.

Since hydrogen flowing along the hydrogen transfer pipe 60 is collected in the water tank 20, it may contain moisture. Moisture is a kind of impurity, and thus, a dehumidifier 62 configured to remove the moisture may be installed in the hydrogen transfer pipe 60.

In the same manner, oxygen generated in the water electrolysis reactor 40 may be stored in the subsidiary water tank 30 at a higher pressure.

The oxygen generated at the anode 412 may be supplied to the subsidiary water tank 30 via the the oxygen collection pipe 50b. The oxygen supplied to the subsidiary water tank 30 is collected in an accommodation space 31 other than the portion of the subsidiary water tank 30 in which water is stored. Therefore, the oxygen collection pipe 50b may be connected to the upper portion of the subsidiary water tank 30. In this case, the oxygen generated at the anode 412 may move towards the subsidiary water tank 30 without external power.

The oxygen collected in the accommodation space 31 is stored in the oxygen storage tank 80b via the oxygen transfer pipe 70. First, in the closed state of a pressure control valve 71 installed in the oxygen transfer pipe 70, the oxygen is continuously supplied to the accommodation space 31. As the amount of the collected oxygen increases, pressure applied to the oxygen is increased. When the pressure of the oxygen becomes equal to or higher than a predetermined pressure, the pressure control valve 71 is opened and the high-pressure oxygen is supplied to the oxygen storage tank 80b via the oxygen transfer pipe 70. The pressure control value 71 may include a lid 71a configured to prevent movement of the oxygen and an elastic member 71b moving in connection with the lid 71a, without being limited thereto.

Since oxygen flowing along the oxygen transfer pipe 70 is collected in the subsidiary water tank 30, it may contain moisture. Moisture is a kind of impurity, and thus, a dehumidifier 72 configured to remove the moisture may be installed in the oxygen transfer pipe 70.

The hydrogen production and storage system 1 according to the present invention is an energy system which converts solar energy into electric energy through the solar panel 10, operates the water electrolysis reactor 40 using the electric energy to produce hydrogen, and stores the hydrogen in the hydrogen storage tank 80a at a high pressure through the water tank 20 and the pressure control valve 61.

The hydrogen production and storage system 1 may produce and store hydrogen without separate external power, and be easily installed within a small occupation space because the respective elements are disposed in the inner space of the support formed by the frames A.

As is apparent from the above description, a hydrogen production and storage system using solar energy according to the present invention may be autonomously operated using only electric energy produced by a solar panel without external power.

Further, the hydrogen production and storage system using solar energy according to the present invention may produce high-pressure hydrogen without any external power source, such as a compressor, during a process of converting solar energy into hydrogen energy.

In addition, the hydrogen production and storage system using solar energy according to the present invention may be easily installed, because the shapes, sizes, etc. of respective devices forming the hydrogen production and storage system appropriately adjusted so that the devices are packaged.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A hydrogen production and storage system using solar energy, comprising:
a solar panel configured to produce electric energy from sunlight;
a water tank configured to store water;
a water electrolysis reactor configured to receive the water from the water tank and to decompose the water so as to produce hydrogen, and operated by the electric energy received from the solar panel;
a hydrogen collection pipe connected to the water electrolysis reactor and the water tank so as to supply the hydrogen produced by the water electrolysis reactor to the water tank; and
a hydrogen storage tank connected to the water tank through a hydrogen transfer pipe so as to receive and store the hydrogen collected in the water tank.

2. The hydrogen production and storage system of claim 1, further comprising a subsidiary water tank spatially separated from the water tank and configured to store water,
wherein the water electrolysis reactor receives the water from at least one of the water tank or the subsidiary water tank and decomposes the water so as to produce the hydrogen and oxygen.

3. The hydrogen production and storage system of claim 1, further comprising:
an oxygen collection pipe connected to the water electrolysis reactor and the subsidiary water tank so as to supply the oxygen produced by the water electrolysis reactor to the subsidiary water tank; and
an oxygen collection tank connected to the subsidiary water tank through an oxygen transfer pipe so as to receive and store the oxygen collected in the subsidiary water tank.

4. The hydrogen production and storage system of claim 1, wherein:
the solar panel is installed at an incline on an upper surface of a support formed by combining a plurality of frames; and
at least one of the water tank, the water electrolysis reactor or the hydrogen storage tank is received in an inner space formed by the solar panel and the support.

5. The hydrogen production and storage system of claim 1, wherein the solar panel comprises a first panel configured to absorb at least one of infrared light or ultraviolet light and to produce electric energy, and a second panel configured to absorb visible light and to produce electric energy.

6. The hydrogen production and storage system of claim 5, wherein the first panel is installed on a front surface of the second panel.

7. The hydrogen production and storage system of claim 1, wherein the water tank is installed on a rear surface of the solar panel, and a heat exchange pad configured to transmit heat generated from the solar panel to the water tank is interposed between the water tank and the solar panel.

8. The hydrogen production and storage system of claim 1, wherein the water electrolysis reactor comprises:
at least one water electrolysis cell comprising a cathode configured to generate hydrogen, an anode configured to generate oxygen, and a cation exchange membrane interposed between the cathode and the anode; and
a hydrogen channel having one side communicating with the cathode and a remaining side communicating with the hydrogen collection pipe so as to guide the hydrogen generated at the cathode to the hydrogen collection pipe.

9. The hydrogen production and storage system of claim 3, wherein the water electrolysis reactor comprises:
at least one water electrolysis cell comprising a cathode configured to generate hydrogen, an anode configured to generate oxygen, and a cation exchange membrane interposed between the cathode and the anode; and
an oxygen channel having one side communicating with the anode and a remaining side communicating with the oxygen collection pipe so as to guide the oxygen generated at the anode to the oxygen collection pipe.

10. The hydrogen production and storage system of claim 8, wherein the water electrolysis reactor is formed by stacking a plurality of water electrolysis cells.

11. The hydrogen production and storage system of claim 1, wherein the hydrogen supplied to the water tank via the hydrogen collection pipe is collected in an accommodation space other than a portion of the water tank in which the water is stored, the hydrogen is pressurized as an amount of the collected hydrogen increases in a closed state of a pressure control valve installed in the hydrogen transfer pipe, and the hydrogen is stored in the hydrogen storage tank when a pressure of the hydrogen becomes equal to or higher than a predetermined pressure and the pressure control valve is opened.

12. The hydrogen production and storage system of claim 3, wherein the oxygen supplied to the subsidiary water tank via the oxygen collection pipe is collected in an accommodation space other than a portion of the subsidiary water tank in which the water is stored, the oxygen is pressurized as an amount of the collected oxygen increases in a closed state of a pressure control valve installed in the oxygen transfer pipe, and the oxygen is stored in the oxygen storage tank when a pressure of the oxygen becomes equal to or higher than a predetermined pressure and the pressure control valve is opened.

13. The hydrogen production and storage system of claim 1, further comprising a dehumidifier installed in the hydrogen transfer pipe to remove moisture from the hydrogen flowing in the hydrogen transfer pipe.

14. The hydrogen production and storage system of claim 3, further comprising a dehumidifier installed in the oxygen transfer pipe to remove moisture from the oxygen flowing in the oxygen transfer pipe.

15. The hydrogen production and storage system of claim 1, wherein power from an external power source is not supplied to the hydrogen production and storage system.
